(19) United States
(12) Patent Application Publication
(10) Pub. No.: US 2013/0294351 A1
(43) Pub. Date: Nov. 7, 2013

(54) APPARATUS AND METHOD FOR TRANSMITTING CHANNEL STATE INFORMATION IN A WIRELESS COMMUNICATION SYSTEM

(71) Applicants: Ki Bum Kwon, Seoul (KR); Jae Hyun Ahn, Seoul (KR); Si Hyung Kim, Seoul (KR); Kyung Min Park, Seoul (KR)

(72) Inventors: Ki Bum Kwon, Seoul (KR); Jae Hyun Ahn, Seoul (KR); Si Hyung Kim, Seoul (KR); Kyung Min Park, Seoul (KR)

(73) Assignee: Pantech Co., Ltd., Seoul (KR)

(21) Appl. No.: 13/979,071

(22) PCT Filed: Jan. 17, 2012
(86) PCT No.: PCT/KR2012/000379

§ 371 Date: Jul. 10, 2013

(30) Foreign Application Priority Data
Jan. 17, 2011 (KR) 10-2011-0004684
Feb. 11, 2011 (KR) 10-2011-0012456
Feb. 15, 2011 (KR) 10-2011-0013217

(51) Int. Cl. H04W 24/10

(52) U.S. Cl. CPC H04W 24/10
USPC 370/328

(57) ABSTRACT

The present description relates to a method and apparatus for transmitting channel state information in a wireless communication system. The method comprises the following steps: receiving, from a base station, information indicating a linkage between a cell set including a serving cell and a subset including a subframe; configuring channel state information for the subframe on the serving cell; receiving, from the base station, channel-state-information-request information indicating the cell set; and transmitting the channel state information to the base station. According to the present invention, channel state information, which varies as time elapses, may be accurately measured, and channel state information of the point in time desired by the base station may be provided.

### CROSS-REFERENCE TO RELATED APPLICATIONS

This application is the National Stage Entry of International Application No. PCT/KR2012/000379, filed on Jan. 17, 2012, and claims priority to and the benefit of Korean Application No. 10-2011-0004684, filed Jan. 17, 2011, Korean Application No. 10-2011-0012456, filed Feb. 11, 2011, and Korean Application No. 10-2011-0013217, filed Feb. 15, 2011 which are hereby incorporated by reference as if fully set forth herein.

### BACKGROUND

1. Field

The present invention relates to wireless communication, and more particularly, to a method and apparatus for transmitting channel state information in a wireless communication is system.

2. Discussion of the Background

3rd Generation Partnership Project (3GPP) Long Term Evolution (LTE) that is the improvement of a Universal Mobile Telecommunications System (UMTS) is introduced in 3GPP release 8. The 3GPP LTE uses Orthogonal Frequency Division Multiple Access (OFDMA) in downlink and uses Single Carrier-Frequency Division Multiple Access (SC-FDMA) in uplink. The 3GPP LTE adopts Multiple Input Multiple Output (MIMO) having a maximum of 4 antennas. A discussion on 3GPP LTE-Advanced (LTE-A) that is the evolution of the 3GPP LTE is recently in progress.

With the development of wireless communication technology, a heterogeneous network environment comes to the front. In the heterogeneous network environment, a macro cell, a femto cell, a pico cell, etc. are used. Each of the femto cell and the pico cell, as compared to the macro cell, is a system that covers an area smaller than the existing mobile communication service radius. In this communication system, a user terminal existing in any one of the macro cell, the femto cell, and the pico cell experiences inter-cell interference caused by signal interference due to signals generated from other cells.

### SUMMARY

An object of the present invention is to provide an apparatus and method for transmitting channel state information in a wireless communication system.

Another object of the present invention is to provide an apparatus and method for is transmitting channel state information for each subset.

Yet another object of the present invention is to provide a method for transmitting information about the linkage between a cell set and a subset.

A further object of the present invention is to provide an apparatus and method for aperiodically transmitting channel state information based on the linkage between a cell set and a subset.

A further object of the present invention is to provide an apparatus and method for periodically transmitting channel state information.

A further object of the present invention is to provide an apparatus and method for periodically transmitting channel state information about a combination of multiple subsets.

According to an embodiment of the present invention, there is provided a method for transmitting channel state information by a UE in a wireless communication system. The method comprises the steps of: receiving, from a base station, information indicating a linkage between a cell set including a serving cell and a subset including a subframe; configuring channel state information for the subframe on the serving cell; receiving, from the base station, channel-state-information-request information indicating the cell set; and transmitting the channel state information to the base station.

According to another embodiment of the present invention, there is provided a UE for transmitting channel state information in a wireless communication system. The UE comprises: a downlink reception unit that receives, from a base station, information indicating a is linkage between a cell set including a serving cell and a subset including a subframe and channel-state-information-request information indicating the cell set; a channel state information configuration unit that measures a channel state for the subframe on the serving cell, and configures channel state information indicating the measured channel state; and an uplink transmission unit that transmits the channel state information to the base station.

According to yet another embodiment of the present invention, there is provided a method for receiving channel state information by a base station in a wireless communication system. The method comprises the steps of: transmitting, to a UE, information indicating a linkage between a cell set including a serving cell and a subset including a subframe; transmitting, to the UE, channel-state-information-request information indicating the cell set; and receiving the channel state information from the UE.

According to a further embodiment of the present invention, there is provided a base station for receiving channel state information in a wireless communication system. The base station comprises: a downlink transmission unit that transmits, to a UE, information indicating a linkage between a cell set including a serving cell and a subset including a subframe and channel-state-information-request information indicating the cell set; a channel-state-information-request generation unit that generates the channel-state-information-request information to be transmitted on a physical downlink control channel (PDCCH); and an uplink reception unit that receives the channel state information from the UE.

According to a further embodiment of the present invention, there is provided a is method for periodically transmitting channel state information by a UE in a wireless communication system. The method comprises the steps of: determining whether there exists at least one of a change in the report period of channel state information, a subset change, and an ABS pattern change; if a subset change exists, measuring a channel state for the changed subset; and if there exists a change in the report period of channel state information, transmitting, to a base station, channel state information indicating the measured channel state, based on the changed report period of channel state information.

The subset comprises at least one subframe for which the channel state information is to be reported.

If various forms of cells, such as a macro cell, a micro cell, a pico cell, and a femto cell, exist and a TDM scheme is used to control interference occurring between the cells, channel state information varying with time can be measured more precisely and channel state information at a time point desired by a scheduler can be secured in accordance with the TDM scheme. Accordingly, a scheduling gain for the resource allocation of a serving cell can be improved.

### BRIEF DESCRIPTION OF THE DRAWINGS

FIG. 1 is a diagram schematically illustrating the concept of a heterogeneous network composed of a macro cell, a femto cell, and a pico cell.

FIG. 2 is a diagram schematically illustrating that a UE is influenced by is interference between a macro cell, a femto cell, and a pico cell in downlink.

FIG. 3 is a diagram showing a frame pattern for inter-cell interference control in a heterogeneous network system.

FIG. 4 is an explanatory diagram illustrating the concept of a Primary Serving Cell and a Secondary Serving Cell.

FIG. 5 is a flowchart illustrating a method of transmitting channel state information according to an embodiment of the present invention.

FIG. 6 is a block diagram showing a UE transmitting channel state information and a base station receiving it according to an embodiment of the present invention.

FIG. 7 is a conceptual view illustrating a method of periodically transmitting channel state information for two subsets according to an embodiment of the present invention.

FIG. 8 is a flowchart illustrating a method of transmitting channel state information according to another embodiment of the present invention.

FIG. 9 is a flowchart illustrating a method of periodically transmitting channel state information by a UE according to an embodiment of the present invention.

FIG. 10 is a flowchart illustrating a procedure in which a base station selects a scheme for periodically transmitting channel state information according to an embodiment of the present invention.

### DETAILED DESCRIPTION OF THE ILLUSTRATED EMBODIMENTS

Hereinafter, in this specification, the contents related to the present invention will be described in detail in connection with exemplary embodiments with reference to the accompanying drawings. It is to be noted that in assigning reference numerals to respective elements in the drawings, the same reference numerals designate the same elements throughout the drawings although the elements are shown in different drawings. Furthermore, in describing the embodiments of the present invention, a detailed description of the known functions and constructions will be omitted if it is deemed to make the gist of the present invention unnecessarily vague.

In this specification, a wireless communication network is chiefly described as the subject. Tasks performed in the communication network may be performed in a process in which a system (e.g., a base station) managing the wireless communication network controls the wireless communication network and sends data or may be performed in a user equipment connected to the wireless communication network.

In a heterogeneous network in which heterogeneous cells exist in the same space, it is necessary to coordinate interference between the heterogeneous cells along with scheduling for a user equipment.

It is difficult to satisfy a demand for increasing data service by simply dividing cells into macro cells and micro cells. To solve this problem, data service may be provided to indoor and outdoor small-sized areas by using a pico cell, a femto cell, a wireless relay, etc. Although the small-sized cells are not limited to specific purposes, the pico cell may be chiefly is used in a communication shadow area not covered by only the macro cell or an area requiring a lot of data service (so called a hot zone). The femto cell may be chiefly used in indoor offices or homes. Furthermore, the wireless relay may supplement the coverage of the macro cell.

If a heterogeneous network is configured, the shadow area of data service can be obviated and the data transfer rate can also be increased.

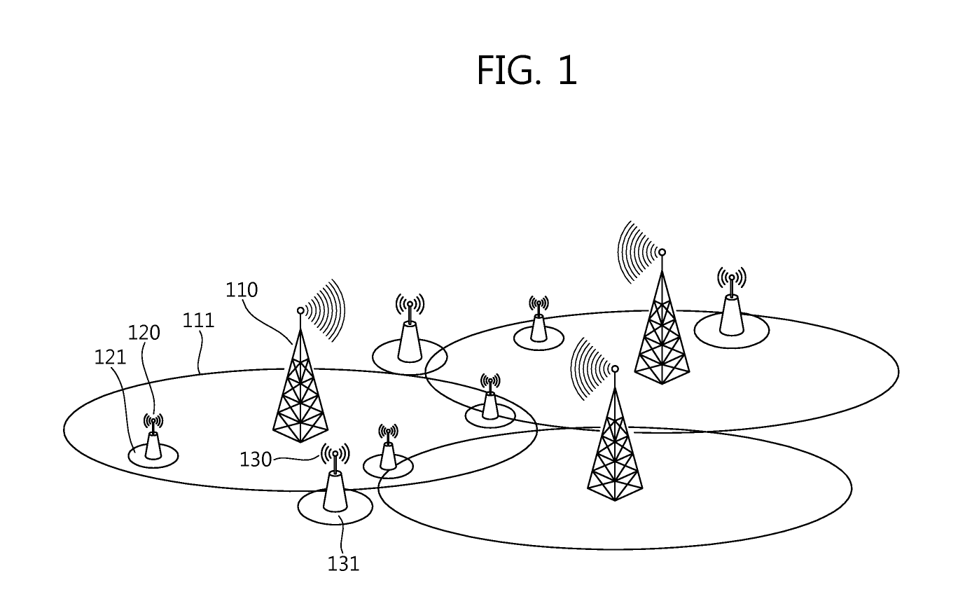

FIG. 1 is a diagram schematically illustrating the concept of a heterogeneous network composed of a macro cell, a femto cell, and a pico cell.

Referring to FIG. 1, a macro BS 110, a femto BS 120, and a pico BS 130 are operated in the heterogeneous network. The macro BS 110, the femto BS 120, and the pico BS 130 have their own cell coverage 111, 121, and 131. A cell provided by the macro BS 110 is called a macro cell 111, a cell provided by the femto BS 120 is called a femto cell 121, and a cell provided by the pico BS 130 is called a pico cell 131.

The femto BS 120 is a low-power wireless access point, for example, a BS for ultra small-sized mobile communication, which is used in the interior of a home, office, etc. The femto BS 120 may access a mobile communication core network by using a DSL, a cable broadband, etc. of a home or an office. The femto BS 120 is connected to a mobile communication network over a wired network, such as an Internet network. A UE within the femto cell 120 may access the mobile communication core network or the Internet network through the femto BS 120.

The femto BS 120 supports a self-organization function. The self-organization is function is classified into a self-configuration function, a self-optimization function, a self-monitoring function, etc. The self-configuration function is a function that enables the femto BS itself to install a wireless BS on the basis of an initial installation profile without experiencing a cell planning step. The self-optimization function is a function of optimizing a list of neighbor BSs by identifying neighboring BSs and obtaining pieces of information from the BSs and of optimizing coverage and communication capacity according to a change of subscribers and traffic. The self-monitoring function is a function of performing control based on gathered information so that service performance is not deteriorated.

The femto BS 120 may divide users into registered users and unregistered users and allow only the registered users to access thereto. A cell that allows only a registered user to access thereto is called a Closed Subscriber Group (hereinafter referred to as a ‘CSG’), and a cell that allows common users to access thereto is called an Open Subscriber Group (hereinafter referred to as an ‘OSG’). Furthermore, the CSG and the OSG may be mixed and operated.

The femto BS 120 may also be called a Home NodeB (HNB) or a Home eNodeB (HeNB). In the following specification, an HNB and a HeNB are collectively called the femto BS 120. A basic object of the femto BS 120 is to provide services specific to members belonging to a CSG. The femto BS 120, however, may provide service to users other than a CSG, depending on the operation mode configuration of the femto BS 120.

The heterogeneous network, consisting of the macro cell, the femto cell, and the pico cell, has been described with reference to FIG. 1, for convenience of description, but the is heterogeneous network may be formed of a relay or different types of cells.

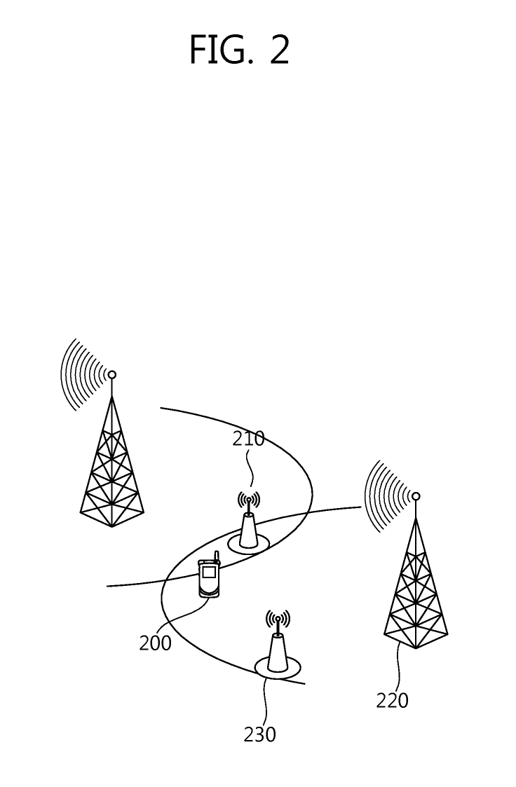

FIG. 2 is a diagram schematically illustrating that a UE is influenced by interference between a macro cell, a femto cell, and a pico cell in downlink.

Referring to FIG. 2, a UE 200 and a femto BS 210 are placed at the cell edge of a macro cell provided by a macro BS 220. The femto BS 210 is in a CSG mode. If the UE 200 is not registered with the CSG regarding the femto BS 210, the UE 200 is unable to access the femto BS 210 having strong signal intensity, and the UE 200 inevitably accesses the macro BS 220 having relatively weaker signal intensity than the femto BS 210. In this case, the UE 200 can receive an interference signal from the femto BS 210.

Furthermore, the UE 200 may use a pico cell provided by a pico BS 230, but may be influenced by interference due to the macro cell 220.

In a heterogeneous network system, a victim cell that is greatly influenced by interference or must be protected from interference in relation to inter-cell interference between a macro cell and a femto cell is the macro cell. On the other hand, an aggressor cell that gives influences to a victim cell or that is less influenced by interference is the femto cell. This is because the interference influencing a weak signal of the macro BS 220 is greater than the interference influencing a strong signal of the femto BS 210, and the number of users who use the femto BS 210 is much larger than the number of users who use the macro BS 220. In other words, it is highly likely that there will be UEs incapable of moving to femto cells, among the UEs within the macro cell that have entered the area where strong signals of the femto BS 210 is are received.

A method of reducing inter-cell interference includes Inter-Cell Interference Coordination (hereinafter referred to as ‘ICIC’) or enhanced ICIC (eICIC). In general, the ICIC method is a method of supporting reliable communication for a UE accessing a victim cell when the UE is influenced by interference from an aggressor cell. In order to coordinate inter-cell interference, restrictions may be imposed to a scheduler in relation to the use of specific time resources and/or specific frequency resources. Furthermore, restrictions may be imposed to a scheduler regarding how much power will be used for specific time resources and/or specific frequency resources.

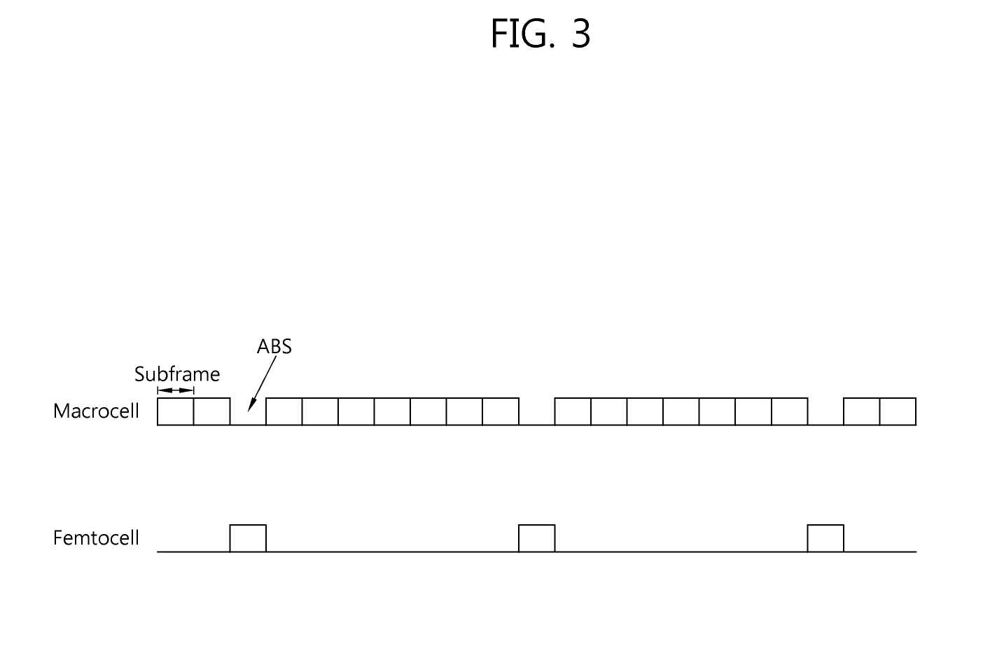

FIG. 3 is a diagram showing a frame pattern for ICIC in a heterogeneous network system.

Referring to FIG. 3, in order to coordinate interference between heterogeneous cells (e.g., between a macro cell and a femto cell or a macro cell and a pico cell), a new frame pattern may be configured. For example, in the third subframe of a macro cell, the macro cell rarely transmits a signal so that the signal strength is extremely low. Accordingly, almost no signal is transmitted in the third subframe, and the subframe is called almost blank subframe (ABS). ABS is occupied by a femto cell and keeps a UE from any interference from a macro cell. A subframe consisting of a frame of a specific pattern in order to remove interference is called an Almost Blank Subframe (ABS). The frame pattern may also be called an ABS pattern. In the ABS pattern, interference is coordinated by variably configuring a frame pattern structure is itself within a specific periodic section consisting of a plurality of subframes.

A method in which heterogeneous cells divide and use subframes (i.e., time resources) among them in order to coordinate interference is called Time Division Multiplexing (hereinafter referred to as ‘TDM’) ICIC. In the TDM ICIC method, an example in which heterogeneous cells divide and use time resources among them by the subframe is described in the present invention, but the example is only an embodiment. That is, the technical spirit of the present invention includes all embodiments in which heterogeneous cells divide and use time resources by the slot, by the frame, or by the specific time that may be defined. Furthermore, the TDM ICIC method according to the present invention is chiefly described by specifying only interference between a macro cell and a femto cell, but this is only an example. For example, the TDM ICIC method of the present invention may also be applied to interference between a macro cell and a pico cell and interference between a pico cell and a femto cell.

A macro BS and a femto BS can perform communication on the basis of the ABS pattern. For example, a first subframe may be almost exclusively used by the macro BS, and a second subframe may be almost exclusively used by the femto BS. Alternatively, the macro BS may use the second subframe, used by the femto BS, only for MSs within the macro BS which are in places where the MSs cannot receive the signal of the femto BS. The femto BS may not at all schedule the first subframe because the macro BS exclusively uses the first subframe. In general, in order to perform scheduling, a BS has to know the state of a downlink channel. The femto BS does not need to receive the state of the downlink channel for the first subframe is because it has a low interest in the scheduling of the first subframe. The macro BS and the femto BS may have only to know the states of downlink channels for respective interested subframes. Meanwhile, a UE needs to measure channels only for determined subframes, because unnecessary power is consumed if the UE performs channel measurement for subframes for which a BS to which a serving cell belongs does not transmit information to the UE, and this may lead to a reduction in the lifespan of the battery.

For this reason, the macro BS or the femto BS may want to receive only Channel State Information (hereinafter referred to as ‘CSI’) about a specific subframe, complying with the operation of an ABS pattern, from a UE. For example, the specific subframe can be any subframe. Alternatively, the specific subframe may be an ABS or a non-ABS. The non-ABS has an opposite concept to the ABS.

From a viewpoint of the UE, the UE may measure only a channel state for subframes predetermined by the macro BS or the femto BS and may feed relevant CSI back thereto. A set of subframes predetermined as the position (or object) for which the channel state will be measured by the UE is called a subset. The number of subsets is not limited. For example, the number of subsets may be 0 or 2. For example, a first subset may be {0, 2, 4}, and a second subset may be {1, 3, 5}. In a subset {a}, ‘a’ is the index of a subframe. The subset may be indicated by a bitmap. For example, it is assumed that subframes included in a subset, from among all the subframes 1, 2, 3, 4, and 5, are {2, 4, 5}. When the subframes are sequentially mapped to a bitmap, the bitmap indicates 01011. If the bit is 1, a relevant subframe is included in is the subset. If the bit is 0, the relevant subframe is not included in the subset.

Subset configuration information is related to the configuration of the subset. The subset configuration information may be transmitted to a UE through the Radio Resource Control (RRC) signaling of a BS. In the above example, a BS informs a UE that the first subset has been configured as {0, 2, 4} and the second subset has been configured as {1, 3, 5}, in the form of subset configuration information.

The UE may be overloaded if a channel state for all the subsets is measured, and a BS has only to obtain CSI about a necessary subset. To this end, the BS is required to inform the UE of a subset requiring CSI, from among a plurality of subsets. For example, the BS may request CSI about a first subset or CSI about a second subset. The UE gives feedback on CSI about the subsets indicated by the BS. For example, if the BS indicates the second subset (e.g., {1, 3, 5}), the UE may give the BS feedback on CSI about the subframe 1, CSI about the subframe 3, and CSI about the subframe 5.

As a method of indicating the subset, a subset indicator (i.e., additional information to indicate the subset) may be newly defined within downlink control information (or an uplink grant) of a format 0 or 4. Here, the subset indicator has 1 bit. If the bit is ‘0’, the subset indicator may indicate a first subset, and if the bit is ‘1’, the subset indicator may indicate a second subset. To additionally add the subset indicator, however, may cause blind decoding overload to a UE because the addition of the subset indicator corresponds to a modification of the existing downlink control information format. In order to avoid the blind decoding overhead, is another method of efficiently indicating the subset is required.

Hereinafter, CSI and a cell set will be described first, and then a method of indicating a subset will be described in detail.

1. CSI and Cell Set

CSI refers to information indicating a channel state for a transmission link (e.g., downlink), and a UE may know a channel state by measuring a CSI reference signal for measuring the channel state. CSI may include, for example, a Channel Quality Indicator (CQI), a Precoding Matrix Indicator (PMI), and a Rank Indicator (RI). Alternatively, CSI may also refer to information induced by a CQI, a PMI, and an RI.

The CQI indicates a Modulation and Coding Scheme (MCS) level suitable for a measured channel state. For example, the CQI may be listed as in Table 1 below.

TABLE 1

| CQI Index | Modulation |
|---|---|
| 0 | out of range |
| 1 | QPSK |
| 2 | QPSK |
| 3 | QPSK |
| 4 | QPSK |
| 5 | QPSK |
| 6 | QPSK |
| 7 | 16QAM |
| 8 | 16QAM |
| 9 | 16QAM |
| 10 | 64QAN |
| 11 | 64QAN |
| 12 | 64QAN |
| 13 | 64QAN |
| 14 | 64QAN |
| 15 | 64QAN |

The PMI provides information about a precoding matrix in codebook-based precoding. The PMI is related to Multiple Input Multiple Output (MIMO). In the MIMO, what the PMI is fed back is referred to as a closed loop MIMO.

The RI is information about the number of layers or a rank which is recommended by a UE. The rank is the number of non-zero eigenvalues of an MIMO channel matrix and may be defined by the number of spatial streams that may be multiplexed.

The RI is always related to one or more CQI feedbacks. That is, a feedback CQI is calculated assuming a specific RI value. The RI may be fed back by a frequency smaller than that of a CQI because the rank of a channel is changed more slowly than the CQI. For example, the transmission cycle of an RI may be a multiple of the transmission cycle of a CQI or a PMI.

A method of transmitting CSI includes a periodic transmission method and an aperiodic transmission method. In the periodic transmission method, the CSI may be transmitted on a Physical Uplink Control Channel (PUCCH) or on a Physical Uplink Shared Channel (PUSCH). In the aperiodic transmission method, more detailed, larger-capacity channel state is reporting is possible because the CSI is transmitted on a PUSCH. A BS requests a UE to perform the aperiodic transmission method when more precise CSI is required. This request is made when the BS transmits CSI-request information to the UE. The CSI-request information may be included in Downlink Control Information (hereinafter referred to as ‘DCI’) of a format 0 or a format 4. The DCI of the format 0 or the format 4 may be called an uplink grant.

The CSI-request information may be represented by 1 bit or 2 bits. If the CSI-request information is represented by 1 bit, it corresponds to the case where a BS configures only one serving cell for a UE. If the CSI-request information is represented by 2 bits, it corresponds to the case where a BS configures two or more serving cells for a UE. In other words, after the first one serving cell is configured, the CSI-request information of 1 bit may be used. Next, the BS may additionally configure one or more serving cells for the UE. The CSI-request information of 2 bits may be used after the additional serving cells are configured.

TABLE 2

| Value of CSI request | Indication |
|---|---|
| 0 | No aperiodic CSI request |
| 1 | Triggering of an aperiodic CSI report on |
| | a serving cell |

Referring to Table 2, if a value of the CSI-request information is 1, an aperiodic CSI report on a serving cell is triggered.

Meanwhile, CSI-request information supporting a UE in which at least one serving cell (or a plurality of component carriers) is configured may be defined. The following table is an example showing the contents indicated by CSI-request information of 2 bits.

TABLE 3

| Value of CSI | |
|---|---|
| request | Indication |
| 00 | No triggering of an aperiodic CSI report |
| 01 | Triggering of an aperiodic CSI report on a serving cell |
| 10 | Triggering of a CSI report on the serving cells of a first |
| | cell set configured by a higher layer |
| 11 | Triggering of a CSI report on the serving cells of a second |
| | cell set configured by a higher layer |

Referring to Table 3, if the value of the CSI-request information is 01, an aperiodic CSI report on a serving cell is triggered. Here, the CSI relates to downlink component carriers linked together on the basis of an uplink component carrier on which the CSI will be transmitted and uplink frequency information defined within System Information Block (SIB) 2. Furthermore, if the values of the CSI-request information and 10 and 11, it refers to the triggering of a CSI report on the serving cells of the first cell set and the triggering of a CSI report on the serving cells of the second cell set, respectively. Here, the cell set indicates a set including at least one serving cell configured by a higher layer for a UE. For example, the first cell set may be {a serving cell1, a serving cell2, a serving cell3}, and the second cell set may be {a serving cell0, a serving cell4}. If the value of the CSI-request information is 10, a UE transmits CSI about the first cell set (i.e., CSI about the serving cell1, CSI about the serving cell2, and CSI about the serving cell3) to a macro BS, a pico BS, or a femto BS.

In addition, with reference to the above Table 3, the definitions of restrictions of the measurement of CSI (channel state information) and RRM (radio resource management)/RLM (radio link monitoring) can be described only with respect to a primary serving cell.

If the primary serving cell cannot switch to other frequency bands or base stations, in spite of high inter-cell interference, in an inter-cell interference environment, this suggests that the performance of linkage between different frequency bands or base stations is even worse.

In this case, the base station may use an inter-cell interference control technique and configure a subset of separate subframes, in order to obtain CSI, which is represented differently for each subframe. Also, the base station may request a UE to measure CSI for a relevant subframe of the subset consisting of subframes. Hereupon, the UE may alleviate inter-cell interference with the current primary serving cell by measuring and reporting CSI for the relevant subframe of the subset in response to CSI-request information (request value) received from the base station, that is, by using an inter-cell interference control technique in response to a request from the base station.

Regarding this, the elements within a cell set defined in Table 3 are defined as below.

Channel State Reference 0: aperiodic CSI of a primary serving cell measured based on a first CSI subset

Channel State Reference 1: aperiodic CSI of the primary serving cell measured based on a second CSI subset

Channel State Reference 2: aperiodic CSI of a first secondary serving cell measured based on all subframes

Channel State Reference 3: aperiod CSI of the a second secondary serving cell measured based on all subframes

. . .

Channel State Reference N: aperiodic CSI of an (N−2)th secondary serving cell measured based on all subframes

In an example, it is assumed that the base station configures a first cell set to include Channel State Reference 0, Channel State Reference 2, and Channel State Reference 3, and sets the UE to an inter-cell interference control mode.

In this case, the UE measures CSI of the primary serving cell as Channel State Reference 0, based on the first CSI subset, and stores CSI measured based on the subset.

Accordingly, when the UE receives CSI-request information with a value ‘10’, the UE transmits, to the base station, CSI of the primary serving cell measured based on the first CSI subset and CSI of the first and second secondary serving cells based on all the subframes.

In another example, it is assumed that the base station configures a second cell set to include Channel State Reference 1, Channel State Reference 2, and Channel State Reference 3, and sets the UE to the inter-cell interference control mode.

In this case, when the UE receives CSI-request information with a value ‘11’, the UE measures CSI of the primary serving cell measured based on the second CSI subset and CSI of the first and second secondary serving cells based on all the subframes, and transmits them to the base station.

If the UE is not set to the inter-cell interference control mode, the UE does not use a subset. That is, the UE does not need to measure based on the CSI subsets because it is not set to the inter-cell interference control mode.

In other words, the UE does not perform measurement based on the CSI subsets defined in Channel State Reference 0 and Channel State Reference 1.

Information indicating the configuration of a cell set is referred to as cell set configuration information. The cell set configuration information may be transmitted through RRC signaling, Medium Access Control (MAC) signaling, or the signaling of a physical layer.

The concept of a serving cell may be defined in a Carrier Aggregation (CA). An individual unit carrier bound by a CA is called a Component Carrier (hereinafter referred to as a ‘CC’). A CC used in downlink transmission is called a DownLink CC (DL CC), and a CC used in uplink transmission is called an UpLink CC (UL CC). Each CC is defined by a bandwidth and is a center frequency. The CC may correspond to a serving cell. A DL CC may configure one serving cell, or a DL CC and an UL CC may be linked to configure one serving cell. However, a serving cell is not configured by only one UL CC.

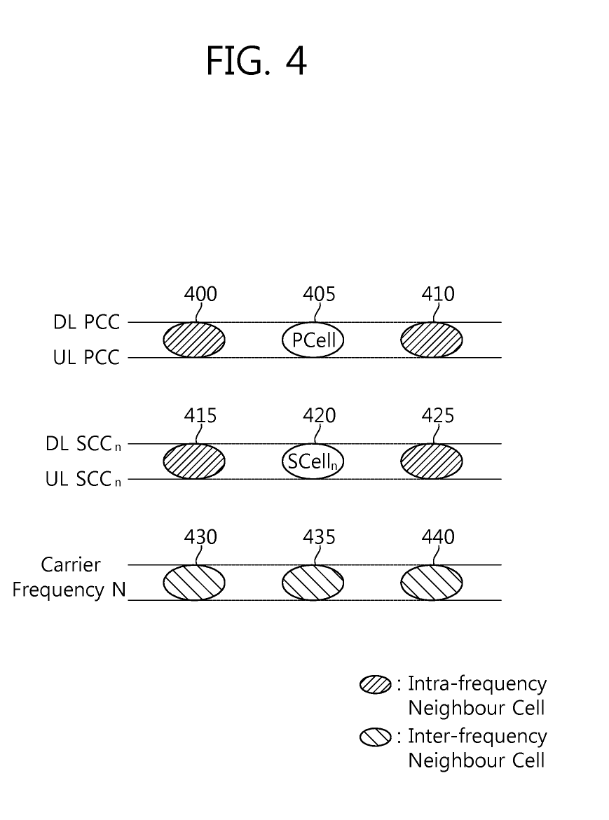

FIG. 4 is an explanatory diagram illustrating the concept of a Primary Serving Cell (hereinafter referred to as a PCell') and a Secondary Serving Cell (hereinafter referred to as a ‘SCell’).

Referring to FIG. 4, serving cells include a PCell 405 and an SCell 420. The remaining cells 400, 410, 415, 425, 430, 435 and 440 other than the serving cells are called neighbor cells. The PCell 405 refers to one serving cell which provides security input and NAS mobility information in an RRC establishment or re-establishment state. At least one cell, together with the PCell 405, may be configured to form a set of serving cells depending on the capabilities of a UE. Here, the at least one cell is called the SCell 420. Accordingly, one group may consist of only the one PCell 405 or may consist of the one PCell 405 and the at least one SCell 420.

A DL CC corresponding to the PCell 405 is called a DownLink Primary Component Carrier (hereinafter referred to as a ‘DL PCC’), and a UL CC corresponding to the PCell 405 is called an UpLink Primary Component Carrier (hereinafter referred to as an ‘UL PCC’). Furthermore, in downlink, a DL CC corresponding to the SCell 420 is called a DownLink Secondary Component Carrier (DL SCC). In uplink, a UL CC corresponding to the SCell 420 is called an UpLink Secondary Component Carrier (UL SCC).

Each of the PCell 405 and the SCell 420 has the following characteristics.

First, the PCell 405 is used to transmit a PUCCH.

Second, the PCell 405 is always activated, whereas the SCell 420 is a carrier activated or deactivated depending on a specific condition.

Third, when the PCell 405 experiences a Radio Link Failure (hereinafter referred to as an ‘RLF’), RRC establishment is triggered. When the SCell 420 experiences an RLF, RRC establishment is not triggered.

Fourth, the PCell 405 may be changed by a change of a security key or a handover procedure accompanied by a Random Access Channel (RACH) procedure. In case of MSG4 (contention resolution), only a PDCCH indicating MSG4 must be transmitted on the PCell 405, and MSG4 information may be transmitted on the PCell 405 or the SCell 420.

Fifth, Non-Access Stratum (NAS) information is received on the PCell 405.

Sixth, the PCell 405 is always composed of a pair of a DL PCC and an UL PCC.

Seventh, a different CC may be configured to the PCell 405 for every UE.

Eighth, procedures, such as the reconfiguration, addition, and removal of the SCell 420, may be performed by an RRC layer. In adding the new SCell 420, RRC signaling may be used to transmit system information about a dedicated SCell.

The technical spirit of the present invention regarding the characteristics of the PCell 405 and the SCell 420 is not necessarily limited to the above description. The characteristics of the PCell 405 and the SCell 420 are only illustrative, and they may include is more examples.

2. A Method of Indicating a Subset

There may be a method of indicating subsets separately, but it requires the burden of additional signaling. To solve this, a subset may be indicated depending on reference information. For example, if reference information has a value 1 or 2, the value 1 of reference information may be implicitly linked to a first subset, and the value 2 of reference information may be implicitly linked to a second subset. That is, if the UE receives the value of reference information=1, it can be seen that the first subset linked with the value of reference information=1 is determined. If the base station wants to indicate the second subset, the base station may transmit the value of reference information=2 to the UE. To implement this, 1:1 linkage needs to exist between reference information and a subset, and the linkage needs to be known in advance between the UE and the base station.

A macro BS or femto BS may notify the UE of information about the linkage by RRC signaling, or broadcast the information to the UE through system information. Otherwise, the base station and the UE may know the linkage in advance. If the linkage between reference information and a subset exists, the macro BS or femto BS may notify the UE of reference information alone to automatically indicate a subset linked with the reference information. Based on this, no additional bit is required to explicitly indicate a subset.

Reference information is downlink information that the macro BS or femto BS transmits to the UE, and may be embodied in various ways. Since a subset is related to CSI, it is may be effective to define information used for the transmission procedure of CSI as reference information.

In an embodiment, reference information having a linkage with a subset may be a cell set. In this case, the linkage exists between the cell set and the subset. Information about the linkage representing the linkage between the cell set and the subset may be defined as in the following Table.

TABLE 4

| Cell set | Subset |
|---|---|
| 1 | 1 |
| 2 | 2 |
| . . . | . . . |
| k | k |

Referring to Table 4, the kth cell set has a linkage with the kth subset. Accordingly, when the kth cell set is specified, the kth subset dependent on the cell set is automatically specified. While this embodiment illustrates that a cell set and a subset have the same index, this is only an embodiment, and the cell set and the subset may have different indices. Information about the linkage may be included, along with cell set configuration information, in an RRC establishment message in an RRC establishment procedure, or in an RRC reconfiguration message in an RRC reconfiguration procedure.

In another embodiment, reference information having a linkage with a subset may be CSI-request information. In this case, the indication of a subset is added to the CSI-request information. Accordingly, the code point of the CSI-request information can be extended. In one aspect, if two cell sets exit, the CSI-request information may be configured as in Table 5.

TABLE 5

| Value | | |
|---|---|---|
| of CSI request | Indication | Subset |
| 00 | No triggering of an aperiodic CSI report | — |
| 01 | Triggering of an aperiodic CSI report on a | — |
| | serving cell | |
| 10 | Triggering of a CSI report on the serving cells | 1 |
| | of a first cell set configured by a higher layer | |
| 11 | Triggering of a CSI report on the serving cells | 2 |
| | of a second cell set configured by a higher | |
| | layer | |

Referring to Table 5, if the macro BS or femto BS transmits CSI-request information having a value ‘11’ to the UE, the UE gives feedback about CSI corresponding to the second subset from the serving cells of the second cell set.

In another aspect, if two cell sets exit, the CSI may be configured as in Table 6.

TABLE 6

| Value | | |
|---|---|---|
| of CSI request | Indication | Subset |
| 00 | No triggering of an aperiodic CSI report | — |
| 01 | Triggering of an aperiodic CSI report on a | — |
| | serving cell | |
| 10 | Triggering of a CSI report on the serving cells | 1 |
| | of a first cell set configured by a higher layer | |
| 11 | Triggering of a CSI report on the serving cells | 2 |
| | of the first cell set configured by a higher | |
| | layer | |

Referring to Table 6, CSI-request information having a value ‘11’ is identical to CSI-request information having a value ‘10’ in that the serving cells comprise the first cell set, however, the two CSI-request information are different from each other in that the UE gives feedback about CSI corresponding to the second subset. Meanwhile, a subset may include all kinds of serving cells (or DL CCs) for aperiodic transmission of CSI. For example, a subset may include a primary serving cell and/or a secondary serving cell. However, if it is assumed that a serving cell indicating a CQI measurement subset is limited to a primary serving cell, the subset may include the primary serving cell alone. In this case, as shown in Table 5, cell sets indicated by ‘10’ and ‘11’ include only the primary serving cell, but include different subsets, respectively. As a result, CSI-request information 10 or 11 involves requesting CSI about the first subset or second subset.

In addition, a CSI request field may be configured such that CSI about both of two measurement restricted subsets are defined for a CSI request value 01 and transmitted. This may be represented as in the following Table 7.

TABLE 7

| Value | | |
|---|---|---|
| of CSI request | Indication | subset |
| 00 | No triggering of an aperiodic CSI report | — |
| 01 | Triggering of an aperiodic CSI report on a | 1, 2 |
| | serving cell | |
| 10 | Triggering of a CSI report on the serving | 1 |
| | cells of a first cell set configured by a | |
| | higher layer | |
| 11 | Triggering of a CSI report on the serving | 2 |
| | cells of the first cell set configured by a | |
| | higher layer | |

If the UE consists of a single serving cell, 1 bit of CSI-request information may be configured as follows.

TABLE 8

| Value of CSI request | Indication | subset |
|---|---|---|
| 0 | No triggering of an aperiodic CSI report | |
| 1 | Triggering of an aperiodic CSI report on | 1, 2 |
| | a serving cell | |

Referring to Table 8, if the value of the CSI-request information is 1, an aperiodic CSI report on a serving cell is triggered, and CSI about both of the two measurement restricted subsets is transmitted.

In another aspect, if two cell sets exit, the CSI-request information may be configured as in Table 5.

TABLE 9

| Value | | |
|---|---|---|
| of CSI request | Indication | subset |
| 00 | No triggering of an aperiodic CSI report | — |
| 01 | Triggering of an aperiodic CSI report on a | — |
| | serving cell | |
| 10 | Triggering of a CSI report on the serving | 1 |
| | cells of a first cell set configured by a higher | |
| | layer | |
| 11 | Triggering of a CSI report on the serving | 1 |
| | cells of a second cell set configured by a | |
| | higher layer | |

Referring to Table 9, CSI-request information having a value ‘11’ is different from CSI-request information having a value ‘10’ in that it indicates to configure a second cell set, however, the two CSI-request information are identical in that the UE gives feedback about CSI corresponding to the second subset.

In addition, a CSI request field may be configured such that information about both of two measurement restricted subsets is defined in advance for CSI request values 10 and 11, respectively, without being transmitted through RRC signaling, as shown in Table 10.

TABLE 10

| Value of | |
|---|---|
| CSI request | Indication |
| 00 | No triggering of an aperiodic CSI report |
| 01 | Triggering of an aperiodic CSI report on a serving cell |
| 10 | Triggering of a CSI report on the serving cells of a first cell |
| | set configured by a higher layer. |
| | If the UE is in a CSI measurement restriction mode, a |
| | measurement value for only a first measurement restricted |
| | subset is taken into account |
| 11 | Triggering of a CSI report on the serving cells of a first cell |
| | set configured by a higher layer. |
| | If the UE is in a CSI measurement restriction mode, a |
| | measurement value for only a second measurement |
| | restricted subset is taken into account |

In another example, a CSI request field may be configured such that CSI about both of two measurement restricted subsets are defined for a CSI request value 01 and transmitted, as shown in Table 11.

TABLE 11

| Value of | |
|---|---|
| CSI request | Indication |
| 00 | No triggering of an aperiodic CSI report |
| 01 | Triggering of an aperiodic CSI report on a serving cell. |
| | If the UE is in a CSI measurement restriction mode, |
| | measurement values for both first and second measurement |
| | restricted subsets are taken into account |
| 10 | Triggering of a CSI report on the serving cells of a first cell |
| | set configured by a higher layer. |
| | If the UE is in a CSI measurement restriction mode, a |
| | measurement value for only a first measurement restricted |
| | subset is taken into account |
| 11 | Triggering of a CSI report on the serving cells of a first cell |
| | set configured by a higher layer. |
| | If the UE is in a CSI measurement restriction mode, a |
| | measurement value for only a second measurement |
| | restricted subset is taken into account |

If the UE consists of a single serving cell, 1 bit of CSI-request information may be configured as follows.

TABLE 12

| Value of | |
|---|---|
| CSI request | Indication |
| 0 | No triggering of an aperiodic CSI report |
| 1 | Triggering of an aperiodic CSI report on a serving cell. |
| | If the UE is in a CSI measurement restriction mode, |
| | measurement values for both first and second measurement |
| | restricted subsets are taken into account |

Referring to Table 12, if the value of the CSI-request information is 1, an aperiodic CSI report on a serving cell is triggered, and CSI about both of the two measurement restricted subsets is transmitted.

3. Aperiodic Transmission of CSI

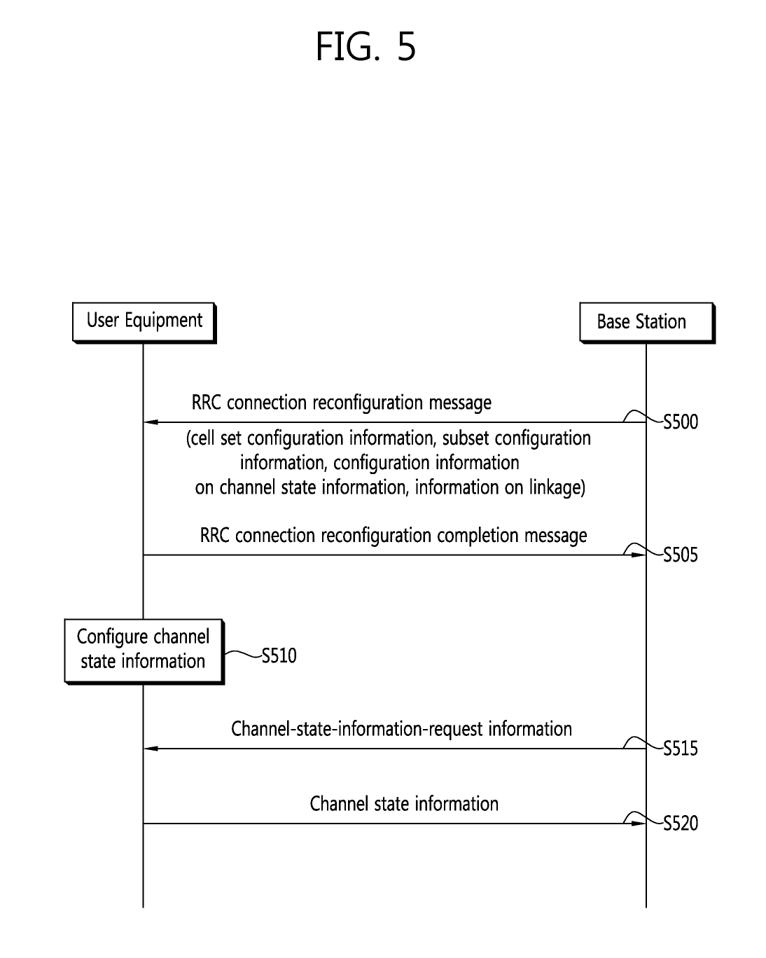

FIG. 5 is a flowchart illustrating a method of transmitting channel state information according to an embodiment of the present invention. Here, a base station may be either a macro BS, a femto BS, or a pico BS.

Referring to FIG. 5, the base station transmits, to the UE, an RRC connection reconfiguration message including cell set configuration information, subset configuration information, and CSI configuration information (S500). At least one cell set is configured for the UE based on the cell set configuration information, and at least one subset is configured for the UE based on the subset configuration information. A linkage exists between at least one cell set and at least one subset, which are configured for the UE, and the linkage may be implicitly agreed between the base station and the UE. Otherwise, as shown in the drawing, linkage-related information indicating the linkage may be included in the RRC connection reconfiguration message and transmitted. The UE may store the linkage-related information. The CSI configuration information is information indicating the settings about the transmission of CQI, PMI, and RI.

The UE reconfigures an RRC connection in response to the RRC connection reconfiguration message and transmits an RRC connection reconfiguration completion message to the BS (S505).

The UE measures a channel state, and configures CSI (S510). The CSI may contain at least one of CQI, PMI, and RI. The UE may measure a channel state in serving cells and time slots (e.g., subframes) determined based on the linkage, and configure CSI indicating the measured channel state. That is, measures a channel state in subframes determined by a cell set and a subset linked with the cell set. For example, it is assumed that there is a linkage between {first cell set=primary serving cell} and {second subset=1, 2, 3}, and there is a linkage between {second cell set=secondary serving cell 1 and secondary serving cell 2} and {second subset=1, 2, 3}. In this case, the UE may measure a first channel state for subframes 1, 2, and 3 of the primary serving cell, measures a second channel state for subframes 1, 2, and 3 of the secondary serving cell 1, or measures a third channel state for subframes 1, 2, and 3 of the secondary serving cell 2. Otherwise, the UE may measure all of the first to third channel states. The UE configures first CSI indicating the first channel state, second CSI indicating the second channel state, and third CSI indicating the third channel state.

The base station transmits CSI-request information to the UE (S515). The CSI-request information may be included and transmitted in Downlink Control Information of a format 0 or a format 4. In this case, the CSI-request information is transmitted over a Physical Downlink Control Channel (PDCCH). The CSI-request information includes, for example, the subset indications shown in Tables 5 through 9.

The UE transmits CSI to the base station (S520). According to the above example, as indicated by the CSI-request information, the UE transmits at least one of the first to is third CSI to the base station. If the CSI request indicates the first cell set, the UE transmits, to the base station, first CSI about the second subset linked with the first cell set. Otherwise, if the CSI request indicates the second cell set, the UE transmits, to the base station, second and third CSI about the second subset linked with the second cell set. The CSI is transmitted over PUSCH.

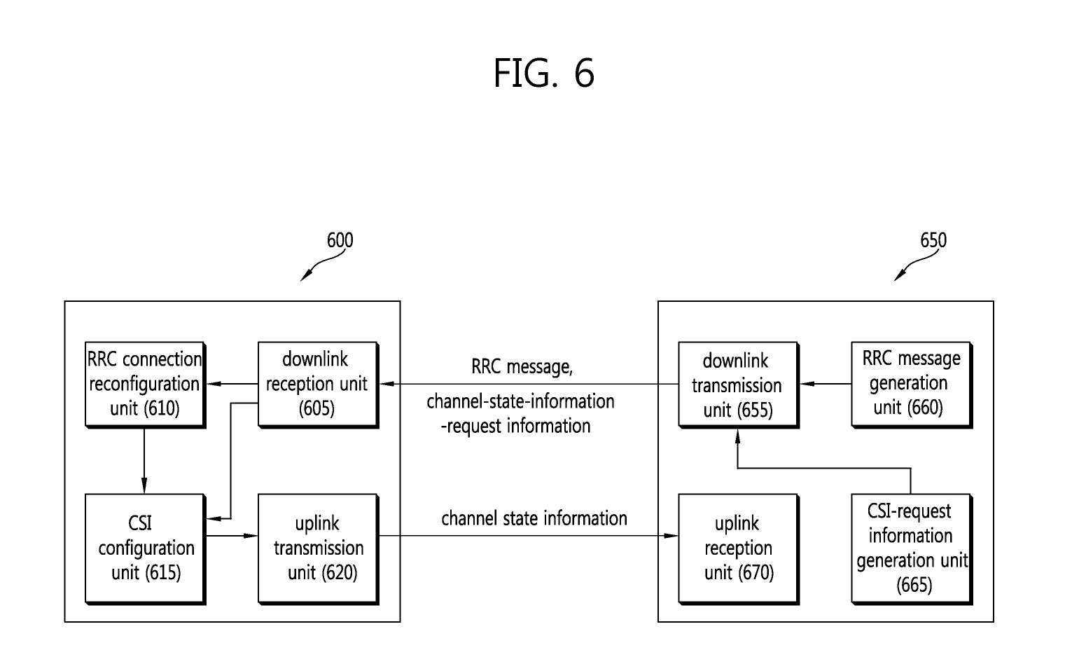

FIG. 6 is a block diagram showing a UE transmitting channel state information and a base station receiving it according to an embodiment of the present invention. Here, a base station may be either a macro BS, a femto BS, or a pico BS.

Referring to FIG. 6, the UE 600 includes a downlink reception unit 605, an RRC connection reconfiguration unit 610, a CSI configuration unit 615, and an uplink transmission unit 620.

The downlink reception unit 605 receives downlink information to be transmitted over downlink by the base station 650, and the downlink information includes an RRC message and CSI-request information. The RRC message includes an RRC connection reconfiguration message. The RRC connection reconfiguration message includes at least one of cell set configuration information, subset configuration information, linkage-related information, and CSI-related information. The CSI-request information is information about a CSI request from the base station to the UE in the aperiodic transmission of CSI.

The RRC connection reconfiguration unit 610 configures a cell set and a subset according to an indication of the RRC connection reconfiguration message received by the downlink reception unit 605, and sets a linkage between the cell set and the subset according to the linkage-related information. Also, the RRC connection reconfiguration unit 610 configures a parameter about the transmission of CSI.

The CSI configuration unit 615 measures a channel state of at least one subframe determined based on the configured cell set, subset, and linkage, and configures CSI. For example, For example, it is assumed that there is a linkage between {first cell set=primary serving cell} and {second subset=1, 2, 3}, and there is a linkage between {second cell set=secondary serving cell 1 and secondary serving cell 2} and {second subset=1, 2, 3}. In this case, the UE may measure a first channel state for subframes 1, 2, and 3 of the primary serving cell, a second channel state for subframes 1, 2, and 3 of the secondary serving cell 1, and a third channel state for subframes 1, 2, and 3 of the secondary serving cell 2, and configures CSI about each channel state.

The uplink transmission unit 620 transmits uplink information to the base station 650. The uplink information includes CSI and an RRC connection reconfiguration completion message. The uplink transmission unit 620 transmits, to the base station 650, CSI configured by the CSI configuration unit 615 over PUSCH. Otherwise, the uplink transmission unit 620 transmits, to the base station 650, an RRC connection reconfiguration completion message in response to the RRC connection reconfiguration message.

The base station 650 includes a downlink transmission unit 655, an RRC message generation unit 660, a CSI-request information generation unit 665, and an uplink reception unit 670.

The downlink transmission unit 655 transmits, to the UE 600, CSI-request information generated by the CSI request generation unit 665. Otherwise, the downlink transmission unit 655 transmits, to the UE 600, an RRC message generated by the RRC message generation unit 660. The RRC message includes an RRC connection reconfiguration message.

The CSI-request information generation unit 665 generates CSI-request information. As described above, the CSI-request information may be included and transmitted in Downlink Control Information of a format 0 or a format 4. In this case, the CSI-request information is transmitted over PDCCH. The CSI-request information includes, for example, the subset indications shown in Tables 5 through 9.

The uplink reception unit 670 receives uplink information to be transmitted over uplink by the UE 600. The uplink information includes CSI.

4. Periodic Transmission of CSI

In the periodic transmission of CSI, the UE transmits CSI according to a predetermined cycle. That is, the UE voluntarily transmits CSI according to a predetermined cycle, even without CSI-request information used in the aperiodic transmission. However, an ABS pattern may be used even in the periodic transmission. Accordingly, once a subset is determined according to an ABS pattern, the UE transmits CSI for a subset according to a predetermined cycle.

A subset may be set in various ways. In an example, each subset may include is different subframes alone. In another example, each subset may include at least one common subframe. In yet another example, all subsets may not include at least one subframe. In a further example, the other subsets may include other subframes than those included in one subset. In a further example, based on an ABS pattern, one subset may include ABS subframes, and the other subsets may include non-ABS subframes.

If a plurality of subsets exist, a different report period may be set for each subset, or a common report period may be set for each subset. If each subset has a different report period, for example, report period P1 is used for the first subset and report period P2 is used for the second subset, the UE may transmit CSI according to a report period corresponding to a selected subset. On the other hand, if a common report period is used, for example, report period P3 is used for both of the first and second subsets, the UE transmits CSI according to report period P3 regardless of which subset is selected.

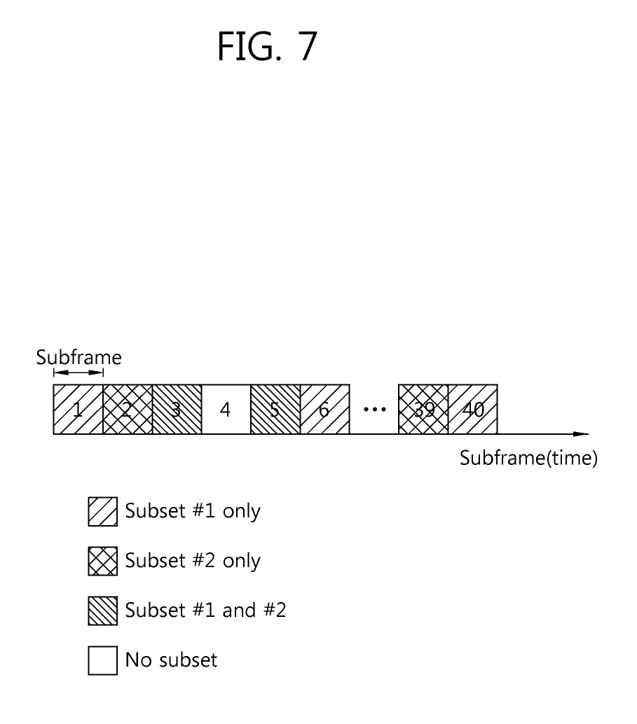

FIG. 7 is a conceptual view illustrating a method of periodically transmitting channel state information for two subsets according to an embodiment of the present invention. In this case, a plurality of separate subsets are linked with one common report period of CSI. That is, each subset does not have their individual report period, but every subset has the same CSI report period.

Referring to FIG. 7, the first subset (subset #1) is {1, 3, 5, 6, . . . , 40}, and the second subset (subset #2) is {2, 3, 5, . . . , 39}. The first subset and the second subset may include different subframes, or common subframes. For example, the subframes commonly included in is the first and second subsets are {3, 5, . . . }. The subframes 1, 6, . . . , 40 are included only in the first subset, and the subframes 2, . . . , 30 are included only in the second subset. On the other hand, the subframe 4 is included in neither of the first and second subsets. That is, the UE does not measure a channel state in the subframe 4 regardless of which subset is indicated by the base station.

In this case, if the CSI report period is two subframes, and transmission starts from the subframe 2, CSI transmission occurs in the subframes 2, 4, 6, . . . , 38, 40. If the first subset is selected, the UE measures a channel state in the subframes 1, 3, 5, 6, . . . , 40 included in the first subset, and transmits CSI in the subframes 2, 4, 6, 8, . . . 38, 40 based on the report period. The CSI measured in the subframe 1 is transmitted in the subframe 2, the CSI measured in the subframe 3 is transmitted in the subframe 4, the CSI measured in the subframe 5 is transmitted in the subframe 6, and the CSI measured in the subframe 6 is transmitted in the subframe 8.

This also applies to when the second subset is selected. Since both the first subset and the second subset are linked with the common report period, CSI is transmitted in the subframes 2, 4, 6, 8, . . . , 38, 40 included in the second subset={2, 3, 5, . . . , 39} according to the same report period.

In the example of FIG. 7, the subframes 3 and 5 are commonly included in the first subset and the second subset, and therefore CSI about the subframe 3 or 5 may be transmitted as long as any of the subsets is specified. However, if the first subset and the second is subset include no common subframe, CSI about the first subset alone is transmitted, and no CSI about the second subset may be transmitted at all. Otherwise, even if the base station specifies the second subset, CSI about some subframes of the second subset may not be transmitted due to the characteristics of the report period. Consequently, the base station cannot acquire CSI about some subframes.

(1) Changing CSI Configuration Parameters

The base station may adjust CSI configuration parameters in order to acquire required CSI about each subset. The base station may transmit the CSI configuration parameters to the UE by higher layer signaling, e.g., RRC signaling. Table 13 shows CQI report configuration information (CQI-ReportConfig) according to an embodiment of the present invention.

TABLE 13

| | |
|---|---|
| -- ASN1START | |
| CQI-ReportConfig ::= | SEQUENCE { |
| cqi-ReportModeAperiodic | ENUMERATED { |
| | rm12, rm20, rm22, rm30, rm31, |
| | spare3, spare2, spare1} OPTIONAL, -- |
| Need OR reporting mode. | |

| | |
|---|---|
| nomPDSCH-RS-EPRE-Offset | INTEGER (−1..6), |

| | | |
|---|---|---|
| cqi-ReportPeriodic | CQI-ReportPeriodic | OPTIONAL - |
| Need ON | | |
| } | | |

| | |
|---|---|
| CQI-ReportConfig-v920 ::= | SEQUENCE { |

| | | | |
|---|---|---|---|
| cqi-Mask-r9 | ENUMERATED {setup} | OPTIONAL, | -- Cond |
| cqi-Setup | | | |
| pmi-RI-Report-r9 | ENUMERATED {setup} | OPTIONAL | -- Cond |
| PMIRI | | | |
| } | | | |

| | |
|---|---|
| CQI-ReportPeriodic ::= | CHOICE { |

| | |
|---|---|
| release | NULL, |
| setup | SEQUENCE { |
| cqi-PUCCH-ResourceIndex | INTEGER (0.. 1185), |

| | |
|---|---|
| cqi-pmi-ConfigIndex | INTEGER (0..1023), |
| cqi-FormatIndicatorPeriodic | CHOICE { |

| | |
|---|---|
| widebandCQI | NULL, |
| subbandCQI | |
| SEQUENCE { | |

| | |
|---|---|
| k | INTEGER (1..4) |

| | | | |
|---|---|---|---|
| } | | | |
| }, | | | |
| ri-ConfigIndex | INTEGER (0..1023) | OPTIONAL, | --Need OR |

| | |
|---|---|
| simultaneousAckNackAndCQI | BOOLEAN |
| } | |
| } | |
| -- ASN1STOP | |

Referring to Table 13, a new reporting mode may be added to CQI report configuration information. The CQI report configuration information includes a CQI-ReportPeriodic field. The report period of CQI or PMI and the subframe offset are determined based on cqi-pmi-ConfigIndex (ICQI/PMI), which is a parameter within the CQI-ReportPeriodic field. The CQI-pmi-ConfigIndex (ICQI/PMI) can be defined as shown in the following table.

TABLE 14

| | | Value of |
|---|---|---|
| I_{CQI/PMI} | Value of Nₚ | N_{OFFSET,CQI} |
| 0 ≦ I_{CQI/PMI} ≦ 1 | 2 | I_{CQI/PMI} |
| 2 ≦ I_{CQI/PMI} ≦ 6 | 5 | I_{CQI/PMI}-2 |
| 7 ≦ I_{CQI/PMI} ≦ 16 | 10 | I_{CQI/PMI}-7 |
| 17 ≦ I_{CQI/PMI} ≦ 36 | 20 | I_{CQI/PMI}-17 |
| 37 ≦ I_{CQI/PMI} ≦ 76 | 40 | I_{CQI/PMI}-37 |
| 77 ≦ I_{CQI/PMI} ≦ 156 | 80 | I_{CQI/PMI}-77 |
| 157 ≦ I_{CQI/PMI} ≦ 316 | 160 | I_{CQI/PMI}-157 |
| I_{CQI/PMI} = 317 | Reserved | |
| 318 ≦ I_{CQI/PMI} ≦ 349 | 32 | I_{CQI/PMI}-318 |
| 350 ≦ I_{CQI/PMI} ≦ 413 | 64 | I_{CQI/PMI}-350 |
| 414 ≦ I_{CQI/PMI} ≦ 541 | 128 | I_{CQI/PMI}-414 |

| | |
|---|---|
| 542 ≦ I_{CQI/PMI} ≦ 1023 | Reserved |

Referring to Table 14, NP is the report period of CQI/PMI, and NOFFSET,CQI indicates the subframe offset where a CQI/PMI report starts. ICQI/PMI is divided into a plurality of ICQI/PMI levels. Table 14 illustrates 12 levels as an example. Each ICQI/PMI level is determined by a range of ICQI/PMI. For example, if 0=ICQI/PMI≦1, level is 0, if 2=ICQI/PMI≦6, level is 1, . . . etc. Each ICQI/PMI level is mapped to a specific combination of a report period and a subframe offset. For example, if ICQI/PMI=90, 77=ICQI/PMI≦156. Therefore, the report period NP=80, and the subframe offset NOFFSET,CQI=13.

Meanwhile, the parameter RI-ConfigIndex (IRI) for determining the report period and subframe offset of RI can be defined as shown in the following Table.

TABLE 15

| I_{RI} | Value of M_{RI} | Value of N_{OFFSET,RI} |
|---|---|---|
| 0 ≦ I_{RI} ≦ 160 | 1 | -I_{RI} |
| 161 ≦ I_{RI} ≦ 321 | 2 | -(I_{RI}-161) |
| 322 ≦ I_{RI} ≦ 482 | 4 | -(I_{RI}-322) |
| 483 ≦ I_{RI} ≦ 643 | 8 | -(I_{RI}-483) |
| 644 ≦ I_{RI} ≦ 804 | 16 | -(I_{RI}-644) |
| 805 ≦ I_{RI} ≦ 965 | 32 | -(I_{RI}-805) |

| | |
|---|---|
| 966 ≦ I_{RI} ≦ 1023 | Reserved |

Referring to Table 15, M_{RI} is the report period of RI, and N_{OFFSET,RI} indicates the subframe offset where an RI report starts. For example, if I_{RI}=320, 161=I_{RI}≦321. Therefore, the report period M_{RI}=2, and the subframe offset N_{OFFSET,RI}=−159.

In this way, when there exist the parameters I_{CQI/PMI} and I_{RI} for determining the report period of transmission of CSI, such as CQI/PMI/RI, and the subframe offset, the base station may change the report period and/or the subframe offset by changing the parameters. Accordingly, the base station can acquire required CSI about each subset.

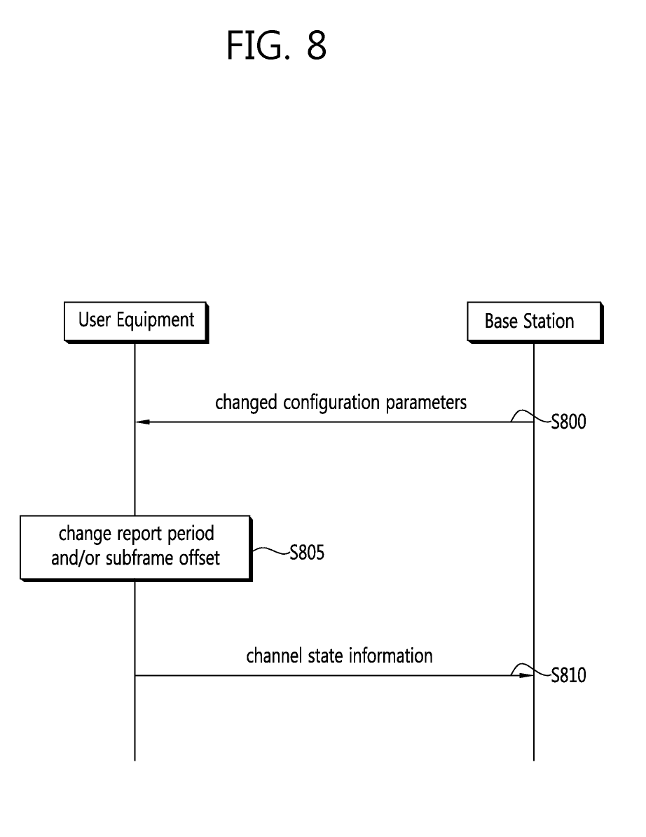

FIG. 8 is a flowchart illustrating a method of transmitting channel state information according to another embodiment of the present invention. Here, a base station may be either a macro BS, a femto BS, or a pico BS. Also, it is assumed that, because a specific subset is specified in advance between the UE and the base station, the UE acquires CSI about the specific subset.

Referring to FIG. 8, the base station transmits changed configuration parameters, different from the previous CSI configuration parameters, to the UE (S800). The values of the changed configuration parameters determine the report period and/or subframe offset of CSI. For example, a specific range of the changed configuration parameters may be mapped to a specific combination of a report period and/or a subframe offset, as shown in Table 14 or 15. Accordingly, the UE changes the report period and/or the subframe offset (S805).

The UE transmits CSI about a specified subset to the base station based on the changed report period and/or the changed subframe offset (S810). All kinds of subsets configured for the UE are linked with the mapped report period and/or the mapped subframe offset.

(2) Changing a Subset (Change of Modification)

It might be difficult to acquire CSI desired by the base station only by changing the CSI configuration parameters. For example, it might be impossible to receive the reception frequency, resolution, etc of CSI about each subset, as desired by the base station, or an ABS pattern configured by a serving cell might be changed due to channel state measurement or other reasons.

In an example, the base station may change a specified subset. For example, it is assumed that a subset consists of a first subset and a second subset, and the first subset is specified for the current UE. With a report period and a subframe offset given, the base station may specify the second subset in order to acquire desired CSI. That is, the base station changes a specified subset. To change a specified subset, the base station may transmit a subset indicator to the UE to indicate a changed subset. The subset indicator may be transmitted by higher layer signaling, e.g., in the form of an RRC message or MAC message. Otherwise, the subset indicator may be transmitted by lower layer signaling, e.g., physical layer signaling.

In another example, the base station may change a subset. For example, it is assumed that a subset consists of a first subset and a second subset, and the first subset is specified for the current UE. With a report period and a subframe offset given, the base station may transmit a changed third subset to the UE and specify the third subset, in order to acquire desired CSI. The third subset may be transmitted in a bitmap format. A subset may be changed by an RRC connection reconfiguration procedure.

(3) Changing an ABS Pattern

If a subset is configured based on an ABS pattern, the type of subset that can be configured in a given single ABS pattern may be limited. That is, if there is a restriction that a subset is determined according to an ABS pattern, the freedom of subset type is low. Accordingly, the base station can change the ABS pattern for other frames than those subframes that need to be always protected. In this case, the base station may negotiate with a neighboring base station (or cell) that may cause interference, and change the ABS pattern as long as it is not affected by interference. Information about a changed ABS pattern may be transmitted from the base station to the UE by higher layer signaling, e.g., RRC signaling.

The methods (1), (2), and (3) may be applied independently or sequentially. For example, the scheduler of the base station may sequentially apply the methods in the order of (1), (2), and (3). When applying the method (2), the CSI configuration parameters that may be changed due to the method (2) have to be taken into account. Also, when applying the method (3), the subset or CSI configuration parameters that may be changed due to the method (3) have to be taken into account.

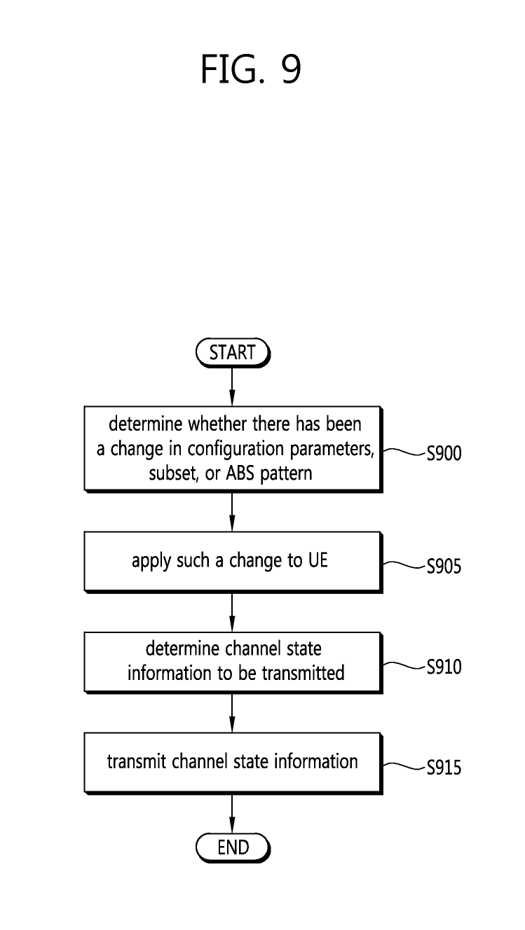

FIG. 9 is a flowchart illustrating a method of periodically transmitting channel state information by a UE according to an embodiment of the present invention.

Referring to FIG. 9, the UE determines whether there has been a change in CSI configuration parameters, subset, or ABS pattern (S900). If any one of these changes is found, the UE ‘applies’ such a change to the UE (S905). For example, a change in CSI configuration is parameters may denote a change in CSI report period and/or subframe offset. In one example, ‘application’ refers to the measurement of a channel state based on a changed report period and/or changed subframe offset. In another example, ‘application’ means that, if there is a subset change, the UE specifies the changed subset and measures a channel state in the subframes included in the changed subset. In another example, ‘application’ means that, if there is an ABS pattern change, the UE measures a channel state according to the changed ABS pattern.

The UE determines CSI to be transmitted (S910). When the UE transmits CSI, there may exist a subframe not included in all the subsets, like the subframe 4 of FIG. 7. Hereinafter, such a subframe is called a hole subframe. It is assumed that periodic transmission has to occur in the subframe right next to the hole subframe. Since the UE cannot measure a channel state in the hole subframe, CSI about the hole subframe cannot be transmitted in the next subframe. However, there is a restriction that periodic transmission of CSI has to be always done in a wireless system, the UE has to determine a subframe, instead of the hole subframe, regarding which the UE will transmit CSI. For example, the UE determines whether it will transmit CSI about the subframe 3 or CSI about the subframe 2. The base station and the UE may determine ‘CSI to be transmitted’ according to a predetermined protocol or by higher layer signaling, such as RRC signaling. CSI is determined as follows.

In an example, the UE determines the most recently acquired CSI as ‘CSI to be transmitted’. In one aspect, the UE may transmit, to the base station, the most recently acquired CSI for any one of a plurality of subsets. For example, the UE has most recently acquired CSI of is the subframe 3 in the first subset, as shown in FIG. 7, and therefore the UE transmits the CSI of the subframe 3 in the subframe 5. In another aspect, the UE may transmit the most recently acquired CSI, among those for all the subsets, to the base station. For example, the UE has most recently acquired CSI of the subframe 3 common for the first and second subsets, as shown in FIG. 7, and therefore the UE transmits the CSI of the subframe 3 in the subframe 5.

In another example, the UE determines CSI according to which subset the subframe corresponding to the previous transmitted CSI is included in. For example, if the previously transmitted CSI is about a subframe of the first subset, the UE determines the most recently measured for the second subset as ‘CSI to be transmitted’.

In yet another example, the UE determines ‘CSI to be transmitted’ based on the number of transmissions of CSI for each subset. In one aspect, the most recently measured CSI for a subset with a smaller number of transmissions is determined as ‘CSI to be transmitted’. For example, if the number of transmissions of CSI for the first subset is 5, and the number of transmissions of CSI for the second subset is 3, the UE transmits the CSI most recently measured for the second subset.

The above examples may be implemented by operating a merged subset by the UE. The merged subset is the sum of various types of subsets. Even if the UE currently measures a channel state based on the first subset, the UE will measure a channel state for the second subset as well.

The UE transmits determined CSI to the base station (S915). CSI transmission is may be performed based on a changed report period and/or changed subframe offset. Periodic CSI may be transmitted over PUCCH or PUSCH.

5. Determination of how to Aperiodically Transmit CSI

When aperiodically transmitting CSI, the following four methods may be taken into account. These four methods are classified according to which restriction is applied to the measurement of a channel state.

(A) Default Method

The default method is used when the base station applies no limitation on the measurement of a channel state by the UE. Accordingly, the UE transmits CSI to the base station according to the conventional periodic transmission method.

(B) Single Subset Linking Method

The base station may transmit information about a plurality of subsets in order to indicate limited measurement when the UE measures a channel state. In this case, a subset to be measured in the operation of reporting periodic CSI, among the plurality of subsets, may be limited to a single subset. Accordingly, the UE transmits CSI to the base station according to the configuration parameters of CSI linked with a single, specified subset. Other subsets than the single, specified subset may be used only for operations (e.g., aperiodic CSI reporting operation) not related to the periodic CSI reporting operation.

(C) Multiple Subset Linking Method

In the multiple subset linking method, two or more subsets each are linked with is their own CSI configuration parameters. Accordingly, when a subset is specified, the UE transmits CSI to the base station, according to the CSI configuration parameters linked with the specified subset.

(D) Merged Subset Method

A merged subset is the sum of various types of subsets. For example, if the first subset=1, 2, 5, 6, and the second subset=1, 3, 7, a merged subset of the first and second subsets=1, 2, 3, 5, 6, 7. The UE may configure a merged subset by merging all of the currently configured subsets, or merging only the subsets specified by the base station. If there exist only two subsets, the UE may configure a merged subset by merging the two subsets, without signaling. The UE measures a channel state for the merged subset, and transmits CSI, which is a measurement result, to the base station.

The base station may select one of the methods (A) to (D) to configure it for the UE.

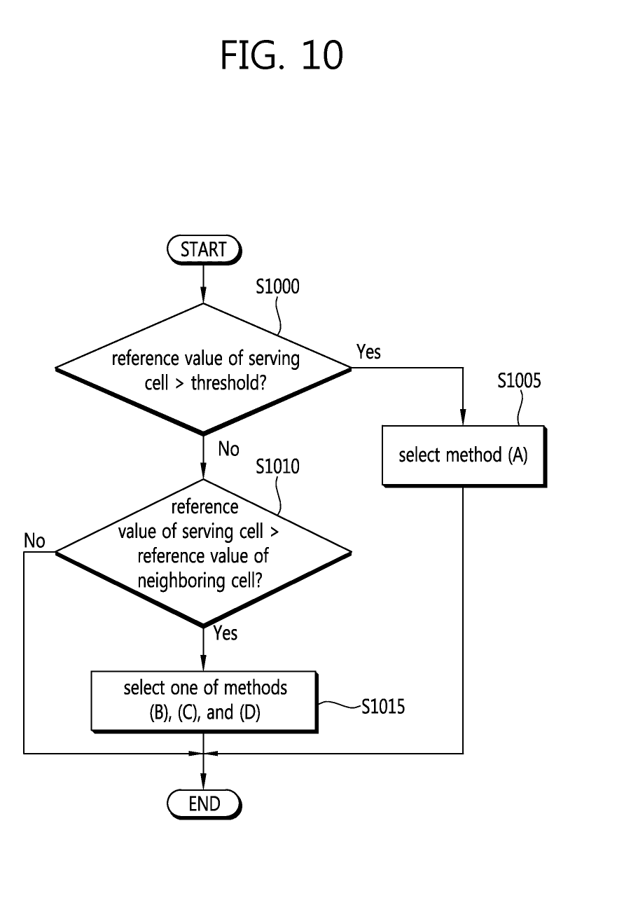

FIG. 10 is a flowchart illustrating a procedure in which a base station selects a scheme for periodically transmitting channel state information according to an embodiment of the present invention.

Referring to FIG. 10, the base station determines whether a reference value of the serving cell is greater than a threshold (S1000). The reference value is RSRP (Reference Signal Received Power) or RSRP (Reference Signal Received Quality). An example of the threshold includes s-measure. s-measure is a comparison value used to determine whether to perform RRM (Radio Resource Management) measurement on a neighboring cell. If the RSRP of the serving cell is greater than s-measure, the UE does not perform RRM measurement on the neighboring cell. The serving cell may be a primary serving cell or secondary serving cell.

If the reference value is greater than the threshold, the base station selects the method (A) (S1005).

If the reference value is less than the threshold, the base station determines whether the reference value of the serving cell is greater than a reference value of the neighboring cell, the base station selects any one of the methods (B) to (D) based on either QoS (Quality of Service) of downlink transmission, or throughput, or latency (S1015), and selects either the method (C) or (D) based on a resolution requirement. For example, if it is determined that CSI about each subset cannot satisfy the resolution requirement through the method (D), the base station selects the method (D).

In periodic transmission of CSI, the UE 600 and base station 650 of FIG. 6 can perform the following operations, respectively.

First, the downlink reception unit 605 of the UE 600 receives, from the base station 650, changed configuration parameters generated by changing the CSI configuration parameters.

The RRC connection reconfiguration unit 610 determines whether there has been a change in CSI configuration parameters, subset, or ABS pattern. If any one of these changes is found, the UE applies such a change to the UE 600.

The CSI configuration unit 615 determines CSI to be transmitted. In an example, the CSI configuration unit 615 determines the most recently acquired CSI as ‘CSI to be transmitted’. In one aspect, the CSI configuration unit 615 may determine the most recently acquired CSI for any one of a plurality of subsets as CSI. In another aspect, the CSI configuration unit 615 may transmit the most recently acquired CSI, among those for all the subsets, as CSI.

In another example, the CSI configuration unit 615 determines CSI according to which subset the subframe corresponding to the previous transmitted CSI is included in. For example, if the previously transmitted CSI is about a subframe of the first subset, the CSI configuration unit 615 determines the CSI most recently measured for the second subset as ‘CSI to be transmitted’.

In yet another example, the CSI configuration unit 615 determines ‘CSI to be transmitted’ based on the number of transmissions of CSI for each subset. In one aspect, the most recently measured CSI for a subset with a smaller number of transmissions is determined as ‘CSI to be transmitted’. For example, if the number of transmissions of CSI for the first subset is 5, and the number of transmissions of CSI for the second subset is 3, the CSI configuration unit 615 transmits the most recently measured for the second subset.

The above examples may be implemented by operating a merged subset by the CSI configuration unit 615. The merged subset is the sum of various types of subsets. Even if the CSI configuration unit 615 currently measures a channel state based on the first subset, the UE will measure a channel state for the second subset as well.

The uplink transmission unit 620 transmits determined CSI to the base station 650. CSI transmission may be performed based on a changed report period and/or changed subframe offset. Periodic CSI may be transmitted over PUCCH or PUSCH.

Next, the RRC message generation unit 660 of the base station 650 generates changed configuration parameters by changing the CSI configuration parameters.

The downlink transmission unit 655 transmits the changed configuration parameters to the UE 600.

The CSI-request information generation unit 665 determines whether a reference value of the serving cell is greater than a threshold. The reference value is RSRP (Reference Signal Received Power) or RSRP (Reference Signal Received Quality). An example of the threshold includes s-measure. s-measure is a comparison value used to determine whether to perform RRM (Radio Resource Management) measurement on a neighboring cell. If the RSRP of the serving cell is greater than s-measure, the UE 600 does not perform RRM measurement on the neighboring cell. The serving cell may be a primary serving cell or secondary serving cell.

If the reference value is greater than the threshold, the CSI-request information generation unit 665 selects the method (A).

If the reference value is less than the threshold, the CSI-request information generation unit 665 determines whether the reference value of the serving cell is greater than a reference value of the neighboring cell, the CSI-request information generation unit 665 selects is any one of the methods (B) to (D) based on either QoS (Quality of Service) of downlink transmission, or throughput, or latency, and selects either the method (C) or (D) based on a resolution requirement. For example, if it is determined that CSI about each subset cannot satisfy the resolution requirement through the method (D), the CSI-request information generation unit 665 selects the method (D).

The uplink reception unit 670 receives CSI from the UE 600.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification is intended to embrace all such alternations, modifications and variations that fall is within the spirit and scope of the appended claims.

1. A method for transmitting channel state information in a wireless communication system, the method comprising the following steps:
receiving, from a base station, information indicating a linkage between a cell set including a serving cell and a subset including a subframe;
configuring channel state information for the subframe on the serving cell;
receiving, from the base station, channel-state-information-request information indicating the cell set; and
transmitting the channel state information to the base station.

2. The method of claim 1, wherein the subset is determined based on an almost blank subframe (ABS) pattern for performing time division multiplexing (TDM) on a frame common to first and second base stations.

3. The method of claim 1, further comprising the step of receiving, from the base station, cell set configuration information for configuring the cell set for a user equipment (UE).

4. The method of claim 1, wherein the information indicating a linkage is a radio resource control (RRC) message.

5. The method of claim 4, wherein the RRC message is an RRC connection reconfiguration message for reconfiguring an RRC connection.

6. The method of claim 1, wherein the channel-state-information-request information is included and received in Downlink Control Information (DCI) of format 0 or 4.

7. The method of claim 1, wherein there are two cell sets, and the channel-state-information-request information is 2-bit information.

8. The method of claim 1, wherein the channel state information is transmitted on a Physical Uplink Control Channel (PUCCH).

9. A user equipment (UE) for transmitting channel state information in a wireless communication system, the UE comprising:
a downlink reception unit which receives, from a base station, information indicating a linkage between a cell set including a serving cell and a subset including a subframe, and channel-state-information-request information indicating the cell set;
a channel state information configuration unit which measures a channel state for the subframe on the serving cell, and configures channel state information indicating the measured channel state; and
an uplink transmission unit which transmits the channel state information to the base station.

10. The UE of claim 9, wherein the subset is determined by the base station, based on an almost blank subframe (ABS) pattern for performing time division multiplexing (TDM) on a frame common to different base stations.

11. The UE of claim 9, wherein the downlink reception unit receives, from the base station, cell set configuration information for configuring the cell set for the UE.

12. The UE of claim 9, wherein the downlink reception unit receives the channel-state-information-request information through Downlink Control Information (DCI) of format 0 or 4.

13. A method for receiving channel state information by a base station in a wireless communication system, the method comprising the steps of:
transmitting, to a user equipment (UE), information indicating a linkage between a cell set including a serving cell and a subset including a subframe;
transmitting, to the UE, channel-state-information-request information indicating the cell set; and
receiving the channel state information from the UE.

14. The method of claim 13, wherein the subset is determined based on an almost blank subframe (ABS) pattern for performing time division multiplexing (TDM) on a frame common to first and second base stations.

15. The method of claim 14, wherein the first base station is a macro base station, and the second base station is a femto base station.

16. A base station for receiving channel state information in a wireless communication system, the base station comprising:
a downlink transmission unit which transmits, to a user equipment (UE), information indicating a linkage between a cell set including a serving cell and a subset including a subframe, and channel-state-information-request information indicating the cell set;
a channel-state-information-request generation unit which generates the channel-state-information-request information to be transmitted on a physical downlink control channel (PDCCH); and
an uplink reception unit which receives the channel state information from the UE.

17. A method for periodically transmitting channel state information by a user equipment (UE) in a wireless communication system, the method comprising the steps of:
determining whether there exists at least one of a change in the report period of channel state information, a subset change, and an almost blank subframe (ABS) pattern change;
measuring a channel state for the changed subset if a subset change exists; and
transmitting, to a base station, channel state information indicating the measured channel state, based on the changed report period of channel state information if there exists a change in the report period of channel state information,
wherein the subset comprises at least one subframe for which the channel state information is to be reported.
